(19) United States
(12) Patent Application Publication
(10) Pub. No.: US 2022/0080372 A1
(43) Pub. Date: Mar. 17, 2022

(54) DILUTION ON MICROFLUIDIC EJECTOR CHIPS

(71) Applicant: Hewlett-Packard Development Company, L.P., Spring, TX (US)

(72) Inventors: Steven Barcelo, Palo Alto, CA (US); Fausto D'Apuzzo, Palo Alto, CA (US); Anita Rogacs, San Diego, CA (US)

(73) Assignee: Hewlett-Packard Development Company, L.P., Spring, TX (US)

(21) Appl. No.: 17/415,217

(22) PCT Filed: Jun. 4, 2019
(86) PCT No.: PCT/US2019/035350

§ 371 Date: Jun. 17, 2021

(51) Int. Cl. B01F 33/301; G01N 21/25; G05D 11/13; B01F 35/83; B01F 31/85

(52) U.S. Cl. CPC B01F 33/3017; G01N 21/255; G01N 2021/258; B01F 35/831; B01F 31/85; G05D 11/13

(57) ABSTRACT

A system and a method for on-chip dilution of a calibration solution are provided. An exemplary system includes a microfluidic ejector chip. The microfluidic ejector chip includes a calibration reservoir to contain a calibration standard and a dilution reservoir to contain a dilution solvent. A first fluid control device couples the calibration reservoir to a mixing chamber, and a second fluid control device couples a dilution reservoir to the mixing chamber. The mixing chamber is fluidically coupled to a microfluidic ejector.

### BACKGROUND

Plasmonic sensing is a powerful tool for trace level chemical detection. However, quantitation may be difficult due to variation in sensors. Various techniques have been tested to improve the quantification, such as incorporating an active compound into the structure of a plasmonic sensor, or incorporating enhanced testing of sensors.

### DESCRIPTION OF THE DRAWINGS

Certain exemplary embodiments are described in the following detailed description and in reference to the drawings, in which:

FIG. 1 is a schematic diagram of a process for the calibration of a plasmonic sensor via on-chip dilution of an analyte solution prior to dispensing volumes of the analyte, in accordance with an example;

FIG. 2 is a schematic drawing of a system for measuring a calibration curve by using on-chip dilution to vary the concentration of dispensed volumes printed on a plasmonic sensor, in accordance with an example;

FIG. 3 is a drawing of a microfluidic ejector chip that includes on-chip dilution elements for a single microfluidic ejector nozzle, in accordance with an example;

FIG. 4 is a drawing of a microfluidic ejector chip that includes multiple sets of on-chip mixing elements for multiple microfluidic ejector nozzles, in accordance with an example;

FIG. 5 is a drawing of a passive mixing chamber, in accordance with an example;

FIG. 6 is a drawing of an active mixing chamber, in accordance with an example;

FIG. 7 is a schematic diagram of a process for using on-chip mixing for creating a series of concentrations to dispense on a sensor for calibration, in accordance with an example;

FIG. 8 is a drawing of a sip-tip system for automatically filling a reservoir, in accordance with an example; and

FIG. 9 is a process flow diagram of a method for on-chip dilution, in accordance with an example.

### DETAILED DESCRIPTION

Plasmonic sensors, including surface enhanced Raman spectroscopy (SERS) sensors, are powerful tools for trace level chemical detection, but often suffer from significant variation between measurements, making quantification difficult. Methods to address this include incorporating reference standards in the fabrication process or exposing multiple sensors to generate sufficient statistics, but these approaches can be complicated and expensive.

To perform sensor calibration, the surface density of the target analyte has to be varied. Accordingly, the dispensing of multiple concentrations is desirable. However, implementing this using multiple dispense-heads requires more manual work and is less cost-effective. The ability to effectively dilute the density of molecules-per-area dispensed on the sensor area would be useful.

Techniques described herein allow for the incorporation of on-chip dilution into a microfluidic ejector chip, which will improve the alignment capabilities, allow better calibration for complex mixtures, and lead to a more automated measurement system. The on chip dilution allows a single nozzle to dispense a complete calibration curve onto a sensor, enabling more precise alignment from a simpler system. Furthermore, storing calibration standards and diluting solvents on chip reduces the risk of contamination during sample preparation. In some cases, multiple nozzles may be used to enable faster processing or complex mixtures.

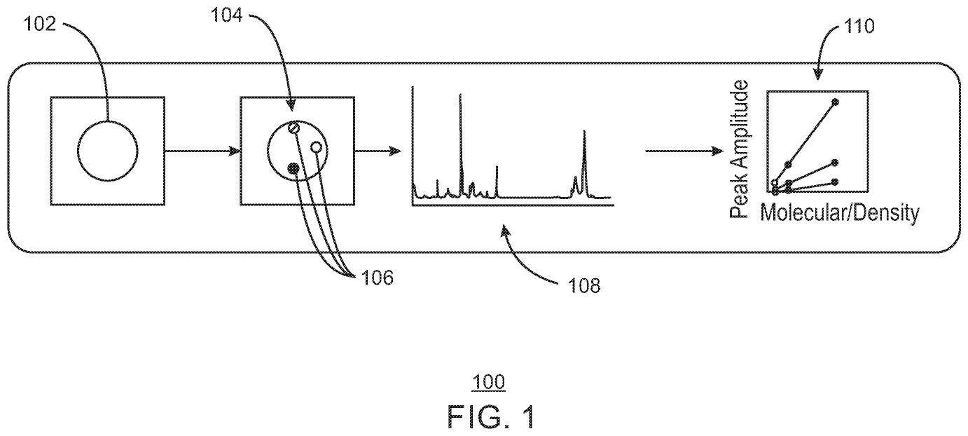

FIG. 1 is a schematic diagram of a process 100 for the calibration of a plasmonic sensor 102 via on-chip dilution of an analyte solution prior to dispensing volumes 104 of the analyte 106, in accordance with an example. In the present techniques, the surface molecular density of the dispensed volumes 104 is controlled by diluting the analyte solution in mixing units built into the chip with the microfluidic ejectors. The molecular density is calculated 108 from the dilution factors, and is used for calibrating a sensor response curve 110.

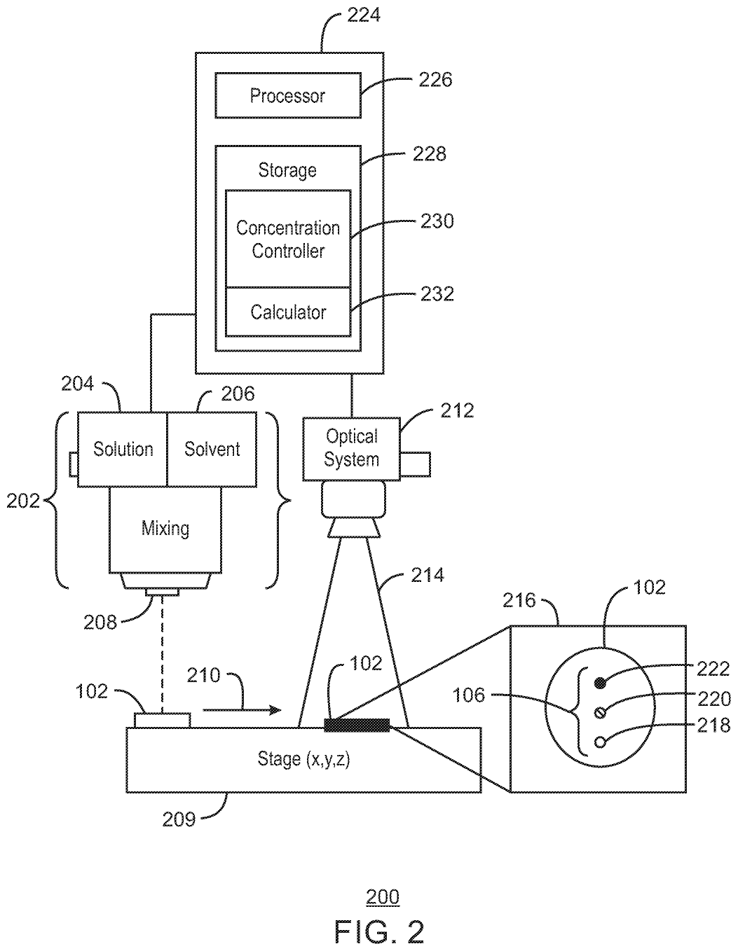

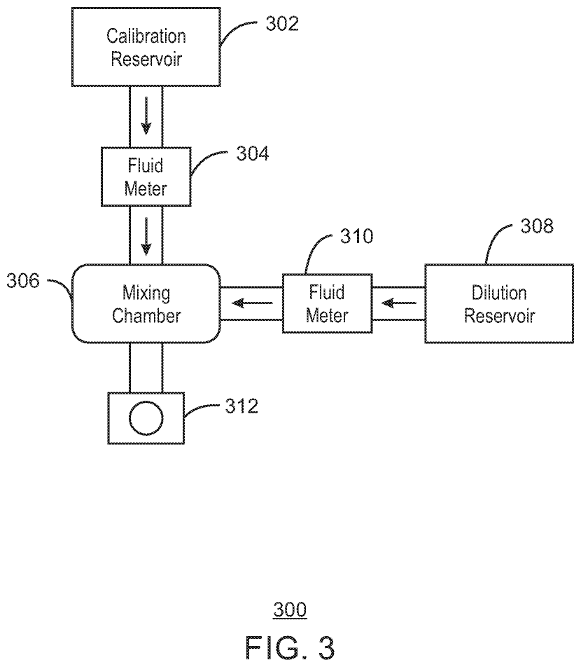

FIG. 2 is a schematic drawing of a system 200 for measuring a calibration curve by using on-chip dilution to vary the concentration of dispensed volumes 104 printed on a plasmonic sensor 102, in accordance with an example. In the system 200, a thermal ink jet (TIJ) chip 202 includes an on-chip analyte reservoir 204 and an on-chip solvent reservoir 206. As described in more detail with respect to FIG. 3, fluid from each of the two reservoirs 204 and 206 is mixed in an on-chip mixing element. The mixed fluid from the on-chip mixing element is then fed to a microfluidic ejector 208 on the chip. The microfluidic ejector 208 on the TIJ chip 202 is primed with a particular dilution by dispensing material into a waste container, followed by dispensing droplets at a particular location of the plasmonic sensor 102.

After the dispensed volumes 104 are ejected onto the plasmonic sensor 102, a translation stage 209 may be used to shift 210 the plasmonic sensor 102 under an optical system 212, which is used to measure 214 a signal (P) from the plasmonic sensor 102. In some examples, the optical system 212 collects an image 216 of the plasmonic sensor 102. The optical system 212 may be a spectrophotometer, a hyperspectral camera, a line scanning spectrophotometer, or any number of other imaging systems that can be used to obtain spectral data, such as emission intensity over a wavelength range. In this example, three spots are formed, a first spot 218 is formed at a first solution concentration, while a second spot 220 is formed at a second solution concentration. A third spot 222 is formed from a third solution concentration.

The system 200 includes a controller 224 that includes a processor 226 configured to control ejections of droplets from the microfluidic ejector 208. The controller 224 includes a data store 228, such as a programmable memory, a hard drive, a server drive, or the like.

The data store 228 includes modules to direct the operation of the system 200. The modules may include a concentration controller 230 that includes instructions that, when executed by the processor, direct the processor to print at least two different concentrations of the analyte on the plasmonic sensor 102. Each of the different concentrations is a spot on the sensor that includes a different mixed concentration that is ejected from the microfluidic ejector 208. The modules may also include a concentration calculator 232 that includes instructions that, when executed by the processor, direct the processor to image 214 the plasmonic sensor 102, measure the signal from the plasmonic sensor 102, for example, caused by emission of light, and calculate the calibration curve based on the response.

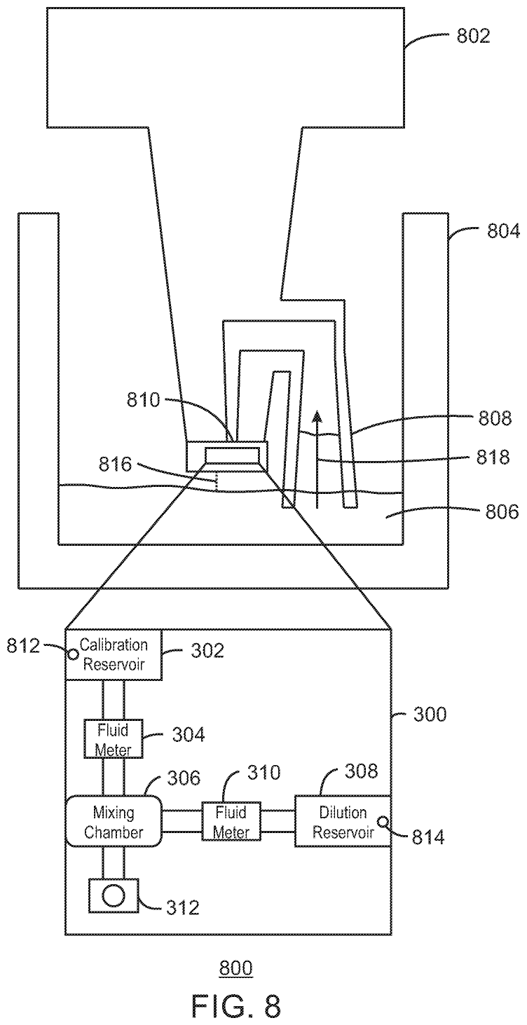

FIG. 3 is a drawing of a microfluidic ejector chip 300 that includes on-chip dilution elements for a single microfluidic ejector nozzle, in accordance with an example. A calibration reservoir 302 may be formed into the chip to hold a calibration solution, or an analyte solution. The calibration reservoir 302 may be refilled, for example, using a syringe to push fluid through a valve, a septum, and the like. The calibration reservoir 302 may include a secondary valve to allow excess material, such as gases or fluids, to pass back out of the calibration reservoir 302, allowing the calibration reservoir 302 to be rinsed. In some examples, the calibration reservoir 302 is pressurized to force fluid out of the calibration reservoir 302. In one example, the calibration reservoir 302 is filled using a “sip tip” sampling mechanism to draw material from a container into the calibration reservoir 302. This is discussed further with respect to FIG. 8.

The calibration reservoir 302 may couple to a calibration fluid meter 304, or fluid control device, to control the amount of fluid moving from the calibration reservoir 302 into a mixing chamber 306. The calibration fluid meter 304 may be a microelectronic mechanical system (MEMS) valve configured to allow a metered amount of fluid to flow from the calibration reservoir 302 to the mixing chamber 306, for example, if the calibration reservoir 302 is pressurized. In other examples, the calibration fluid meter 304 is a MEMS pump, such as a microscopic positive displacement pump based on a gear design, a microfluidic pump based on a thermal ink jet design, or other types of pumps. In some examples, the calibration fluid meter 304 may combine these elements with a flowmeter, such as a thermal pulse flowmeter which measures the flow of a fluid by the speed at which an electrode cools down as fluid flows past.

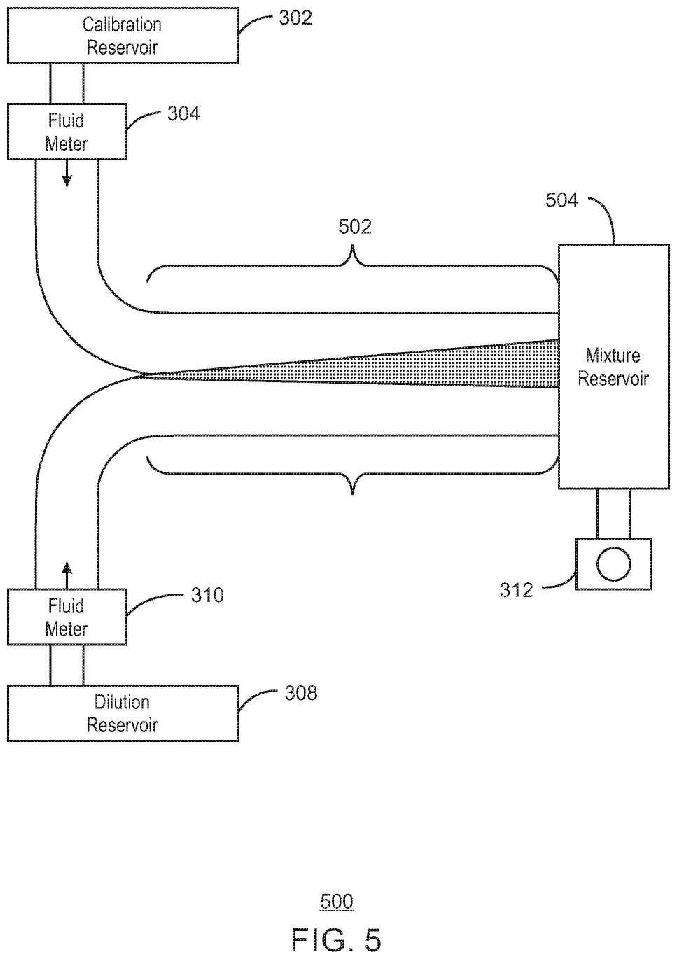

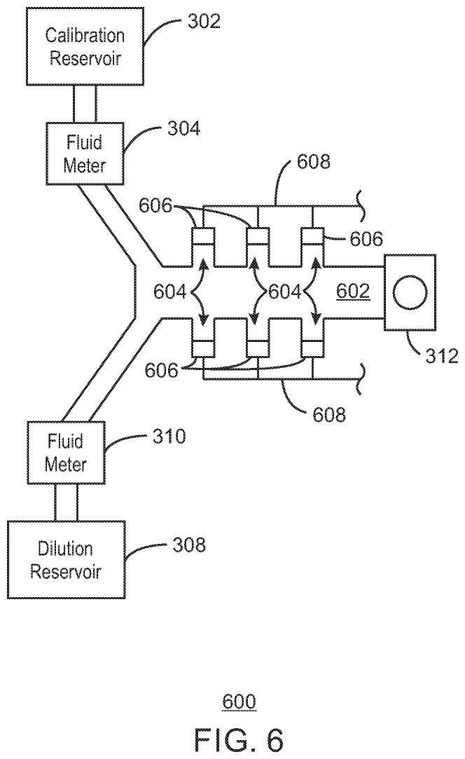

The mixing chamber 306 may be an active mixing chamber, in which energy is used to mix the two fluids with each other, or a passive mixing chamber in which diffusion between the two fluids causes the mixing. This is described in further detail with respect to FIGS. 5 and 6.

A dilution reservoir 308 holds a dilution solvent used to change the concentration of the calibration solution or the analyte. The dilution reservoir 308 may be as described with respect to the calibration reservoir 302, for example, including systems for syringe filling, pressurized flow, or sip tip filling, among others.

The dilution reservoir 308 is fluidically coupled with the mixing chamber 306 through a dilution fluid meter 310. The dilution fluid meter 310 may be as described with respect to the calibration fluid meter 304.

The fluid meters 304 and 310 may be used to ratio the amounts of the calibration solution or dilution solvent to determine the concentration in the mixing chamber 306. In some examples, this is performed by controlling the amount of each of the solutions 304 and 310 that are fed to the mixing chamber 306 by the fluid meters 304 and 310, for example, if the fluid meters are fluid control devices based on pumps. In other examples, the fluid meters 304 and 310 control the amount of each of the solutions 304 and 310 that are fed to the mixing chamber 306 by controlling an amount of time that each of the fluid meters 304 and 310 are open, for example, if the fluid meters are fluid control devices based on MEMS valves.

The mixing chamber 306 feeds the diluted solution to a microfluidic ejector 312. The microfluidic ejector 312 may be a thermal ink jet ejector, or a piezoelectric ejector, or based on other MEMS technologies.

In one example, using the system shown in FIG. 3, two stock solutions are charged to the reservoirs 302 and 308. A calibration standard is charged to the calibration reservoir 302 and the dilution solvent is charged to the dilution reservoir 308. The solutions are mixed and fed into a single mixing chamber 306, from which they are dispensed by the microfluidic ejector 312. As only one mixing chamber is used, the nozzle may be primed in the order of concentrations with lowest concentration solution ejected first. The priming is performed by dispensing droplets into a waste reservoir.

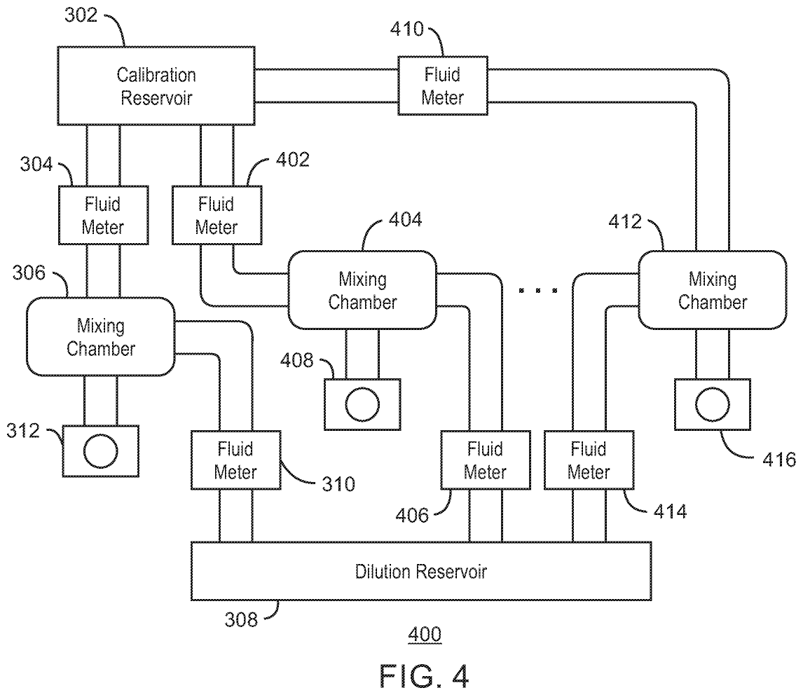

Once the priming is completed, droplets, for example, of about 20 picoliters (pL) in volume, are dispensed onto desired locations on sensors. Excess material may then be dispensed into the waste reservoir, and the next higher concentration mixed in the mixing chamber. This procedure is repeated until all desired concentrations are dispensed onto the sensor. Although this approach lowers the number of elements used on the microfluidic ejector chip, it does take some time to mix and dispense the different concentrations. Accordingly, examples described herein are not limited to a single set of mixing elements on the microfluidic ejector chip 300, but may include multiple mixing elements to create more than one dilution at a time, for example, as described with respect to FIG. 4.

FIG. 4 is a drawing of a microfluidic ejector chip 400 that includes multiple sets of on-chip mixing elements for multiple microfluidic ejector nozzles, in accordance with an example. Like numbered items are as described with respect to FIG. 3.

In the example of FIG. 4, the calibration reservoir 302 is fluidically coupled to a second fluid meter 402 to feed fluid to a second mixing chamber 404. Similarly, a second fluid meter 406 is fluidically coupled to the dilution reservoir 308 to feed fluid to the second mixing chamber 404. The mixed fluid from the second mixing chamber 404 is provided to a second microfluidic ejector 408. In this example, two simultaneous dilutions may be mixed and dispensed.

Further, examples are not limited to only two sets of mixing elements. As shown in FIG. 4, the calibration reservoir 302 may be fluidically coupled to each of a number of calibration fluid meters 410 to provide fluid to each of a number of mixing chambers 412. Similarly, the dilution reservoir 308 may be fluidically coupled to each of a number of dilution fluid meters 414 to provide fluid to each of the mixing chambers 412. Each of the mixing chambers may then provide a mixed fluid to one of a number of microfluidic ejectors 416.

Using the multiple mixing elements, two stock solutions are used to create varying concentrations in multiple on-chip mixing chambers. This establishes a series of concentrations used to create a calibration curve. Each of the concentrations may be dispensed onto the surface of the sensor simultaneously. As each of the concentrations are already mixed, priming will only need to be done once for each set of concentrations. Further, this concept can be expanded to include multiple calibration and dilution reservoirs, enabling the calibration and analysis of complex mixtures.

Mixing of solutions on a microfluidic chip may be difficult due to the small scales involved. Effective techniques basically involve two categories, passive mixing and active mixing.

FIG. 5 is a drawing of a passive mixing chamber 500, in accordance with an example. Like numbered items are as described with respect to FIG. 3. The passive mixing chamber 500 has a flow-through channel 502 to provide a longer contact time frame for diffusion between the calibration solution and the dilution solvent. The length of the flow-through channel, or inter-diffusion region, is determined by the desired contact time. A mixture reservoir 504 may be included to store the mixed solution, provide further contact time, or both. The flow-through channel 502 may be a straight section of tubing, or may include variations, such as S-shaped curves, to increase the contact time. Although the passive mixing chamber 500 is shown in relation to the single set of mixing elements described with respect to FIG. 3, it may be used in any of the other configurations described herein, such as the variation shown in FIG. 4.

FIG. 6 is a drawing of an active mixing chamber 600, in accordance with an example. Like numbered items are as described with respect to FIG. 3. The active mixing chamber has a structured channel 602 through which the two solutions flow. In this example, the structure channel 602 has indentations 604 that include transducers 606 to introduce energy into the structured channel 602.

The transducers 606 may include piezoelectric transducers powered by lines 608 embedded in the microfluidic ejector chip. The piezoelectric transducers may be used to impose an ultrasonic signal on the fluid's in the structure channel 602, causing the formation and collapse of bubbles, which help to mix the solutions.

Other types of transducers 606 may be used to provide an external force, such as pulsed thermal transducers, or pressure transducers. In some examples, opposing transducers 606 on each side of the structured channel are used to set up a gradient, for example, with the transducers 606 on one side of the channel adding heat, and a transducers 606 on the opposite side of the channel removing heat. In this example, flow patterns in the structured channel 602 may mix the fluids.

Another type of transducers 606 that may be used in the active mixing chamber 600 is a pressure perturbation transducer. In one example, a pressure perturbation transducer may use MEMS pistons to change the volume in different regions of the active mixing chamber 600, forcing solutions to move between the different regions, and effecting the mixing. As for the passive mixing chamber 500, described with respect to FIG. 5, the active mixing chamber 600 may include a mixture reservoir to store the mixed solution.

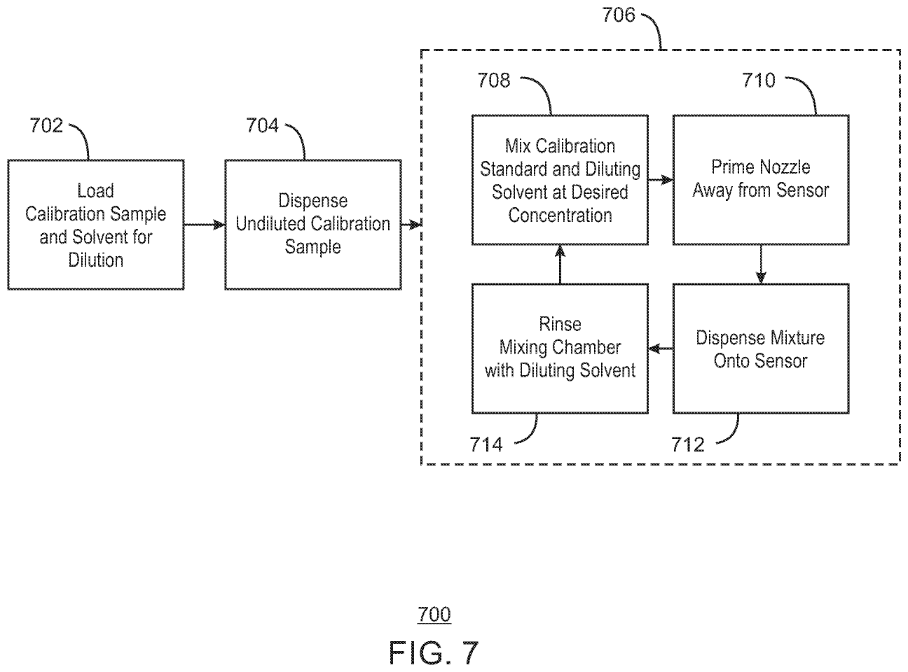

FIG. 7 is a schematic diagram of a process 700 for using on-chip mixing for creating a series of concentrations to dispense on a sensor for calibration, in accordance with an example. The process 700 begins at block 702 when the calibration sample and solvent for dilution are loaded into the on-chip reservoirs. As described herein this may be performed using a syringe, or may be automated using a sip-tip as described further with FIG. 8. Other types of automated systems may be used to fill the reservoirs as well.

At block 704, and undiluted calibration sample may be dispensed onto the sensor. In some examples, this is performed after all other concentrations, for example, to avoid cross-contamination of the mixing chamber and microfluidic ejector with the highest concentration material.

At block 706, a series of actions are repeated for each concentration. Repeating the series of actions may not be needed if a complex microfluidic ejector chip, such as described with respect to FIG. 4, is used to make multiple dilution simultaneously.

At block 708, the calibration solution and dilution solvent are mixed to the desired concentration. At block 710, the microfluidic ejector nozzle is primed into a waste container, or other location away from the sensor. At block 712, the fluidic mixture is dispensed onto the sensor at the desired concentration. At block 714, the mixing chamber is rinsed by passing the diluting solvent through the mixing chamber and dispensing diluting solvent into the waste container.

FIG. 8 is a drawing of a sip-tip system 800 for automatically filling a reservoir, in accordance with an example. Like numbered items are as described with respect to FIG. 3. In the sip-tip system 800, a mounting bracket 802 holds the microfluidic ejector chip 300. The microfluidic ejector chip 300 is moved over a container 804 of a solution 806, such as a calibration solution, and analyte solution, or a dilution solvent.

The mounting bracket 802 is lowered to place the tip 808 of the sip-tip system 800 into the solution 806. A refilling tip 810 may fluidically couple to a port 812 on the calibration reservoir 302, or to a second port 814 on the dilution reservoir 308. The microfluidic ejector 312 may be fired to dispense a train of droplets 816 to lower the pressure in the sip-tip system 800, pulling 818 the solution into the tip 808 of the sip-tip system 800, then through the refilling tip 810 and into the calibration reservoir 302 or the dilution reservoir 308.

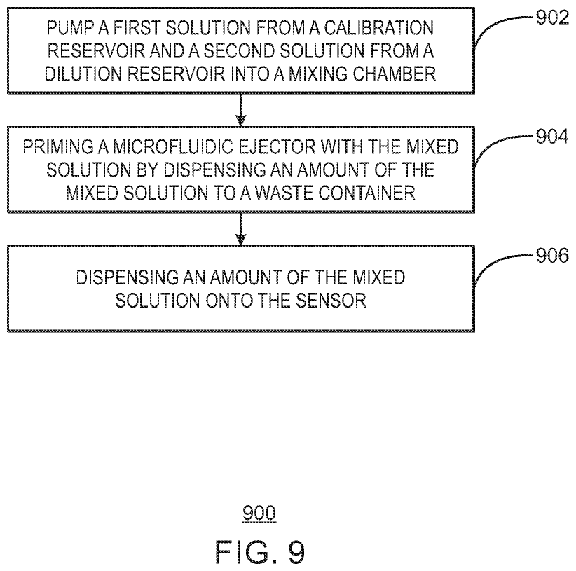

FIG. 9 is a process flow diagram of a method 900 for on-chip dilution, in accordance with an example. The method 900 begins at block 902 when a first solution is pumped from a calibration reservoir into a mixing chamber and a second solution is pumped from a dilution reservoir into the mixing chamber. The concentration of a mixed solution in the mixing chamber is controlled by a ratio of the first solution the second solution. As described herein the calibration reservoir, the dilution reservoir, and the mixing chamber are located on a single microfluidic ejector chip.

At block 904, a microfluidic ejector is primed with the mixed solution by ejecting an amount of the mixed solution to a waste container. After the microfluidic ejector is primed, at block 906, an amount of the mixed solution may be dispensed onto the sensor.

The method of claim 900 may be repeated to create a number of dilutions, with a lowest concentration of the mixed solution dispensed to form a first spot, and a higher concentration of the mixed solution dispensed to form a second spot. Accordingly, an incremental series of concentrations of the mixed solution may be dispensed to form a number of spots for the calibration curve, starting with a lowest concentration, and proceeding to a highest concentration. Between each concentration, the microfluidic ejector may be re-primed to rinse the previous concentration out. In some examples, the mixing chamber may be rinsed with the second solution, from the dilution chamber, to prevent cross-contamination.

As described herein, the microfluidic ejector chip is not limited to a single set of mixing elements, but may have multiple sets of mixing elements. Accordingly, a first solution may be pumped from a calibration reservoir and a second solution may be pumped from a dilution reservoir into a number of mixing chambers at the same time. The concentration of the mixed solution in each of the mixing chambers is controlled by a ratio of the first solution to the second solution. Each mixing chamber feeds a different microfluidic ejector, and all of the microfluidic ejectors may be primed at the same time. An amount of the mixed solution from each of the number of microfluidic ejectors is then dispensed onto the sensor, forming a sequence of concentrations at the same time.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A system, comprising a microfluidic ejector chip, comprising:
a calibration reservoir to contain a calibration standard;
a dilution reservoir to contain a dilution solvent;
a microfluidic ejector;
a mixing chamber fluidically coupled to the microfluidic ejector;
a first fluid control device coupling the calibration reservoir to the mixing chamber; and
a second fluid control device coupling the dilution reservoir to the mixing chamber.

2. The system of claim 1, comprising a port on the calibration reservoir for adding fluid to the calibration reservoir.

3. The system of claim 1, comprising a port on the dilution reservoir for adding fluid to the dilution reservoir.

4. The system of claim 1, wherein the microfluidic ejector comprises a thermal droplet ejection system or a piezoelectric droplet ejection system.

5. The system of claim 1, wherein the mixing chamber comprises a passive mixing chamber comprising an inter-diffusion region.

6. The system of claim 1, wherein the mixing chamber comprises an active mixing chamber comprising a thermal gradient transducer, an ultrasonic transducer, or a pressure perturbation transducer.

7. The system of claim 1, wherein the mixing chamber comprises a mixture reservoir.

8. The system of claim 1, wherein the first fluid control device, the second fluid control device, or both, comprises a MEMS valve.

9. The system of claim 1, wherein the first fluid control device, the second fluid control device, or both, comprises a microfluidic pump.

10. The system of claim 1, wherein the first fluid control device, the second fluid control device, or both, comprises a mass flow meter.

11. A method for dilution on a microfluidic ejector chip, comprising:
pumping a first solution from a calibration reservoir and a second solution from a dilution reservoir into a mixing chamber, wherein a concentration of a mixed solution in the mixing chamber is controlled by a ratio of the first solution to the second solution, and wherein the calibration reservoir, the dilution reservoir, and the mixing chamber are located on the microfluidic ejector chip;
priming a microfluidic ejector with the mixed solution by dispensing a portion of the mixed solution to a waste container; and
dispensing an amount of the mixed solution onto a sensor.

12. The method of claim 11, comprising:
dispensing a lowest concentration of the mixed solution to form a first spot; and
dispensing a higher concentration of the mixed solution to form a second spot.

13. The method of claim 11, comprising incrementally dispensing a series of concentrations of the mixed solution to form a plurality of spots for a calibration curve, starting with a lowest concentration, and proceeding to a highest concentration.

14. The method of claim 13, comprising rinsing the mixing chamber with the second solution between each of the series of concentrations.

15. The method of claim 11, comprising:
pumping the first solution from the calibration reservoir and the second solution from the dilution reservoir into a plurality of mixing chambers, wherein the concentration of the mixed solution in each of the plurality of mixing chambers is controlled by the ratio of the first solution to the second solution;
priming a plurality of microfluidic ejectors wherein each microfluidic ejector is fed from a different one of the plurality of mixing chambers; and
dispensing an amount of the mixed solution from each of the plurality of microfluidic ejectors onto the sensor.
